(19) United States
(12) Patent Application Publication
(10) Pub. No.: US 2017/0008329 A1
(43) Pub. Date: Jan. 12, 2017

(54) AUTOMATIC CIRCULATION BINDER

(71) Applicant: Jiagui ZHONG, Guangdong (CN)

(72) Inventor: Jiagui ZHONG, Guangdong (CN)

(21) Appl. No.: 15/117,724

(22) PCT Filed: May 6, 2014
(86) PCT No.: PCT/CN2014/076845

§ 371 Date: Aug. 9, 2016

(30) Foreign Application Priority Data
Apr. 25, 2014 (CN) 201420208154.5

(51) Int. Cl. B42F 3/04; B42F 13/26; B42F 11/00

(52) U.S. Cl. CPC B42F 3/04; B42F 11/00; B42F 13/26

(57) ABSTRACT

Disclosed is an automatic circulation binder, comprising a housing (1), a pair of pivotable hinged plates (2) which are located in the housing (1) and are tightly clamped by the housing (1), and multiple pairs of half ring elements (3) respectively fixed on the pair of hinged plates (2), wherein the half ring element (3) extends out of an upper surface of the housing (1); the automatic circulation binder also comprises a push rod (4) which is located in the housing (1) and capable of moving in an axial direction of the housing, the push rod (4) is located below the hinged plates (2), and a first through groove (5) and a second through groove (6) are successively provided on the push rod (4) from the left to the right in the axial direction of the housing, wherein an automatic rotation push rod locating sleeve (7) is provided in the first through groove (5) and an upper end of the automatic rotation push rod locating sleeve (7) is fixedly connected to an inner surface of the housing (1), a return spring (8) is provided in the second through groove (6), and the return spring (8) is connected to the hinged plates (2); and a plurality of ejection strips (9) are provided on the upper end of the push rod (4), through grooves (10) are correspondingly provided on the hinged plates (2) such that the ejection strips (9) penetrate through the through grooves (10), and snap grooves (11) matched with the front end of the ejection strips (9) are also located on the inner surface of the housing (1). The automatic circulation binder has a simple structure, and a circulating process of opening and closing can be completed by means of circular pushing with one hand, and the operation is comfortable, easy, and convenient, the usage costs are reduced, and the market demands are met.

### BACKGROUND OF THE INVENTION

The invention relates to a stationery accessory, specifically relates to an automatic loop folder for fixing the paper sheets.

Hole folder belongs to a stationery accessory, generally the trade calls it a binder or a ring folder. Document safekeeping with the folder is safe and secure, pages turn smoothly, it will not scratch the document paper sheet, hook tips are engaged without opening, it is elegant in appearance solid in structure, not prone to scratch or depression, the whole folder strength is improved, and not easy to deform. Generally the folder comprises a rectangular shell, a pair of pivotable hinged plates located in and clamped by the shell and half-ring elements fixed on the hinged plates, those half-ring elements can close or open together with pivotable movement of the hinged plates, when in a closed mode, the two half-ring elements on the corresponding positions of the hinged plates abut together to form a complete ring shackle for fixing and turn the paper, when in an open mode, the ends of the two half-ring elements part from each other to create an opening, so it can remove or add paper sheet through the opening. Currently closing and opening of the folder on the market are controlled with both hands to push aside the two half-ring elements of the hinged plates, this needs a certain force of the hands, and it has to be operated simultaneously with both hands, hand feeling is not good, and the intensity is not uniform, it is easy to damage the folder to increase the costs, when the number of paper sheets in the half-ring elements become relatively more, it is inconvenient to open or close the folder with both hands.

### BRIEF SUMMARY OF THE INVENTION

The invention is intended to effectively overcome the deficiencies of these technologies, provide an automatic loop folder that is simple in structure and can be completely opened and closed with one hand, and it is comfortable, easy, simple and convenient in operation, and reduces the costs.

The invention technical solution is achieved in such a manner: it comprises a shell, a pair of pivotable hinge plates located in and clamped by the shell and several pairs of the half-ring elements fixed on the hinged plates, the said half-ring elements protrude from out of the shell surface, the improvement comprises: it further comprises a push rod located inside the shell and moves along the axial direction of the shell, on the push rod from left to right are the 1st continuous slot and the 2nd continuous slot in sequence along the axial direction of the shell, the said 1st slot is provided with a positioning sleeve of the automatic rotating push rod, upper end of the positioning sleeve of the said automatic rotating push rod is fixed on the inner surface of the shell, the said 2nd slot is equipped with one recoil spring connected with the hinged plates, upper end of the push rod is provided with several mandrils, there are continuous slots at the corresponding positions of the hinged plates, the said mandrils pass through the said continuous slots, and there is a neck on the inner surface of the shell, which matches with the front end of the mandril.

In the structure above, the positioning sleeve of the said automatic rotating push rod comprises a connecting rod cap bushed on the connecting rod, supporting drivepipe, compression spring in the supporting drivepipe, turnplate sleeve and slide pawl sleeve, the left end of the said connecting rod is connected to the left end of the 1st continuous slot, the right end of the connecting rod is connected to the right end of the 1st continuous slot, the upper end of the supporting drivepipe is fixed on the inner surface of the shell, left end of the supporting drivepipe is connected to the cap, there are three embossments on the inner surface of the right end of the supporting drivepipe, which are in parallel with the supporting drivepipe and uniformly distributed, right end of the turnplate sleeve protrudes into the slide pawl sleeve, right end of the slide pawl sleeve is close to the right end of the 1st continuous slot, left end of the turnplate and left end of the slide pawl sleeve are respectively provided with turnplates and slide pawls, there are grooves corresponding to the said embossments on outer circumferential surfaces of the turnplate and slide pawl, turnplate sleeve and slide pawl sleeve can move inside the supporting drivepipe along the embossments via the groove, slide pawl sleeve can drive the turnplate sleeve to move and rotate, the said connecting rod is also provided with a connection block that is near the left end of the turnplate, and one end of the said compression spring is connected with the cap while the other end is connected with the connection block.

Above-mentioned the Construction, the groove outer peripherally divided the described dial surface into three same size wheel lugs, in the right end of wheel lug has a sloping surface and inclined face (tilting in the same direction), vertical face. Described grooves divided the claw external circular surface into three same size slip claw convex block in turn. Among of them, each pair of sliding claw convex blocks include separate first bump and second convex block, which are same size and setup side by side, all has the first inclined plane and a second inclined plane at the left end. Described the rake face should be relatively to the inclined cambered surface stated, and the second inclined plane be correspond to the inclined face. When the first rake face of the first block push against the inclined cambered surface and the second inclined surface of the convex against the inclined face. The turntable jacket rotate, and the first bump into the groove of the turnplate, the left of embossment contacted with the inclined face.

The Construction described above, with AIO open clamp helical surface, close clamp cartridge surface, and the clip helicoid which matches the mentioned card slot on the front end.

The given out the Construction aforesaid, the left and right sides on top of support sleeve respectively equipped with cassette, and the central section with card column, inside the shell surface respectively with corresponding cassette stuck, card column and snaps connected to connecting base and jointed column.

The above the Construction mentioned, the right end is equipped with handle, which is in right end of the described shell.

In the above mentioned the Construction, the right end face of shell extended upward a dam-board, which owns handle grooves corresponding to the described damper.

Within the aforesaid the Construction, the right end of block shot stretched into the stated support casing, the right end face of caps uniformly equipped with three links. The corresponding location on support sleeve has peg hole (with hook clasps inside) linked to described hanger.

In the aforementioned the Construction, each multiple-pair half ring components in half ring components are composed of circular bracelet and oblique bracelet, which can mesh with each other.

This invention beneficial effects are: the Automatic cycle clip provided, is simple construction, through the positioning lock, driving spring and the top bar, set on the automatically rotated positioning sleeve of push rod, driven the push rod cyclical with single hand, might complete the circular opening and closing process of open clip and closed clip, for comfortable and convenient operation, cost reduction, as well as satisfy the market demand.

### BRIEF DESCRIPTION OF THE DRAWINGS

FIG. 1 This 3D invention of the Automatic cycle clip

FIG. 2 This upward view invention of the Automatic cycle clip

FIG. 3 This cutaway view invention of the Automatic cycle clip

FIG. 4 This construction schematic diagram for invention of the Sliding claw sleeve

FIG. 5 This construction schematic diagram for invention of the Swivel plate sleeve

FIG. 6 This construction schematic diagram for invention of the Support sleeve

FIG. 7 This construction schematic diagram for invention of the Block shot

Diagram: 1. the shell; 2. hinged plate; 3. half ring components; 4. the push rod; 5. the first straight slot; 6. the second straight slot; 7. the automatically rotated positioning sleeve of push rod; 8. driving spring ; 9. the top bar; 10. straight slot; 11. the slot; 12. handle; 13. Baffle; 14. The handle groove;

100. linkage; 101. block shot; 102. support sleeve; 103. compression spring; 104. swivel plate sleeve; 105. sliding claw sleeve; 106. convex column; 107. swivel plate; 108. slide claw; 109. groove; 110. link block;

200. convex block of swivel plate; 201. tilted camber surface; 202. vertical surface; 203. tilted face;

300. the first bump; 301. the second convex block; 302. the first inclined plane; 303. the second dip plane;

400. open clamp screw surface; 401. clip the cartridge surface; 402. the clip helical surface;

500. clamping deck; 501. clamping column;

600. Hanger; 601. Peg hole;

700. round looped link; 701. inclined looped link.

### DETAILED DESCRIPTION OF THE INVENTION

Invention combined with the appended drawings below and implement case is for further description.

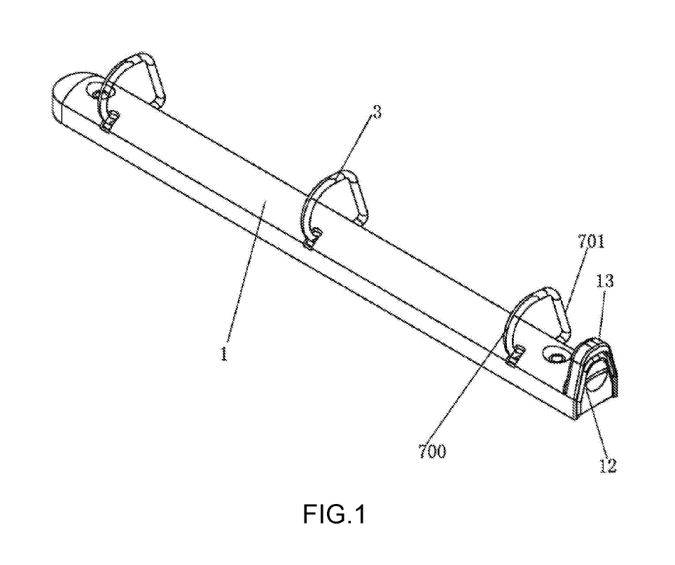

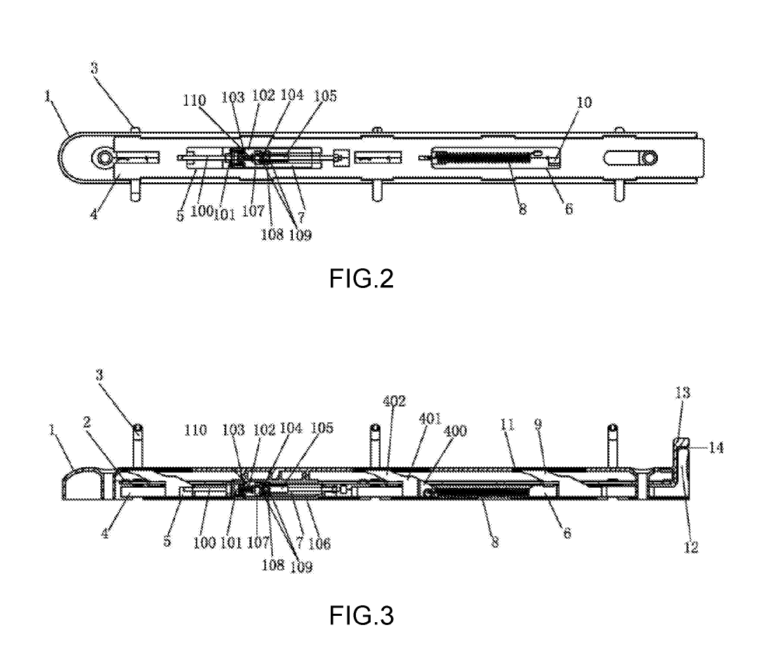

Refer to FIG. 1, FIG. 2 and FIG. 3, the invention reveals the automatic cycle of clip. It includes shell 1, a pair of pivotal hinged plate 2 clamped within shell 1, and multiple pairs of half ring parts 3 which stick out from the shell 1. The parts 3 are three pairs, 3 each half ring components are composed of intermeshing round looped link 700 and oblique looped link 701. Round looped link 700 is beneficial to turn around paper and oblique ring 701 for fixation to collect paper. The automatic cycle clip also includes a handspike 4 located in the shell 1, moving along the shell 1 axis direction. The concrete is a track extended inward on both sides of shell bottom respectively, the push rod 4 move axial direction along the shell inside the orbit, shifting easily, at the bottom of hinged plate. The push rod 4 from left to right along the axis of the shell 1, has the second slot 6 and the first slots 5 in which with an automatically rotated positioning sleeve of push rod 7 to have the effect of positioning lock for push rod 4. The automatically rotated positioning sleeve of push rod 7 fixed connection with shell 1 inner surface, the driving spring 8 set into the second slot 6, to drive pull rod 4 back in the shell 1; the junction place of driving spring 8 and hinged plate 2 gets close to the right end of second slot 6, the top of push rod 4 has multi-peak bar 9 under half ring element 3 with logarithm same as the element 3. Superior to the top of the hinged plate 2 and top bar 9 corresponding location are the crossed slot 10 by top bar 9. The upper part of top bar 9 successively have AIO open clamp screw surface 400, clip the cartridge surface 401 and the clip helical surface 402 matching with clamp slot 11 at front end within shell 1, and at the right end of pushrod) 4 also has handle 12, which at the right end of shell 1 and with hands position for convenience of hand push for push rod 4, the right end face of shell 1 extended upward a damper 13, which with joystick grooves 14 corresponding 12 for expedience and practical.

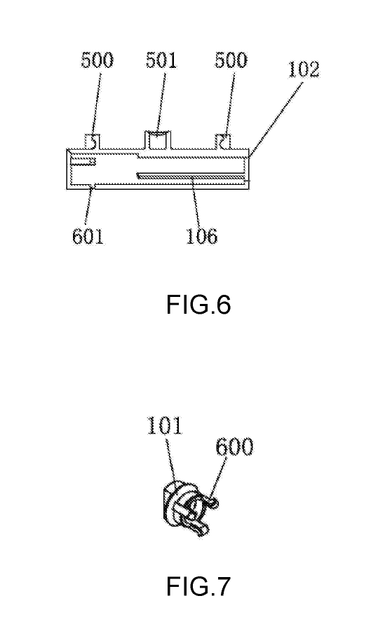

Furthermore, the automatic rotary pushrod locating sleeve 7 includes the joint lever 100, the cap 101, the support sleeve 102, the compression spring 103 in the support sleeve 102, the swivel plate sleeve 104 and the slide claw sleeve 105. The left end of the joint lever 100 is linked with the left end of first groove 5 and the right end of joint lever 100 is linked with the right end of the first groove 5. It is shown in FIG. 6. On the upper part of the support sleeve 102, there is a clamping base 500 equipped on the left and right side respectively. In the middle part of the upper support sleeve, a clamping column is equipped. On the internal surface of shell 1 are joint base and joint pins which are linked to clamping base 500 and clamping column 501 via snap joints separately. It facilitates the installation and can be linked fast. This will prevent the support sleeve 102 from moving with the joint lever 100. The left end of the support sleeve 102 and the cap 101 is fixedly linked. To be specific, the right ends of the cap 101 stretches into the support sleeve 102. See FIG. 7 for reference. On the right end surface of the cap 101, three hangers 600 are evenly equipped in the circumferential direction. In the corresponding positions on the support sleeve 102 there are peg holes 601 matching the hangers 600. The hangers 600 are buckled in the peg holes 601 and linked fast, which prevents the cap 101 from moving with the joint lever 100. On the right-hand internal surface of support sleeve 102, three convex columns 106 are evenly distributed and are axially parallel to the support sleeve 102. The right end of the swivel plate sleeve stretches into the slide claw sleeve 105 and the right end of the slide claw sleeve 105 is close to the right end of the first groove 5. On the left ends of the swivel plate sleeve 104 and the slide claw sleeve 105 are equipped with swivel plate 107 and slide claw 108 respectively. On the peripheral surface of swivel plate 107 and slide claw 108, there are grooves 109 corresponding to the convex columns 106. The swivel plate sleeve 104 and the slide claw sleeve 105 can move in the support sleeve 102 along the convex columns 106 via the grooves 109. The slide claw sleeve 105 can drive the swivel plate sleeve 104 to move and rotate. On the joint lever 100, there is a link block 110. The link block 110 is close to the left end of the swivel plate sleeve and used to prevent the moving of the swivel plate sleeve 104. One end of the compression spring 103 is connected to the cap 101, and the other end to the link block 110.

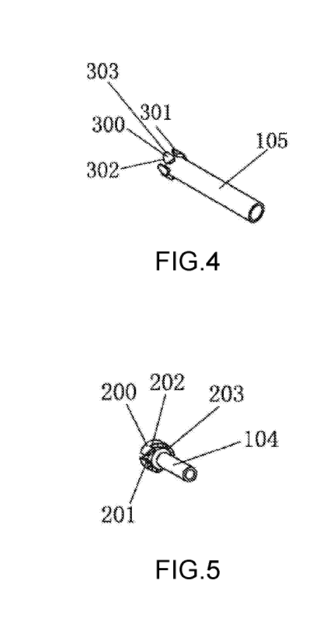

Still refer to FIG. 4 and FIG. 5. The groove 109 divides the outer circumferential surface of the swivel plate 107 into three identical convex block of swivel plate 200. The right end of the convex block of swivel plate 200 has the tilted camber surface 201, the vertical surface 202 and the inclined upright surface 203 in proper order. The tilted camber surface 201 and the inclined upright surface 203 are inclined in the same direction and the left end of convex column 106 is corresponding with the inclined upright surface 203. The groove 109 divides the outer circumferential surface of the slide claw 108 into three identical pairs of slide claw bumps. Among them, each pair of slide claws consists of the first bump 300 and the second convex block 301 and these two are identical and are placed side by side. The left ends of the first bump 300 and the second convex block 301 have the first inclined surface 302 and the second inclined surface 303. And the first inclined surface 302 is at an angle to the second inclined surface 303. The first inclined surface 302 is corresponding with the tilted camber surface 201 and the second inclined surface 303 is corresponding with the inclined upright surface 203. When the first inclined plane 302 of the first bump 300 is pushed against the tilted camber surface 201 and the second inclined plane 303 of the second convex block 301 is pushed against the inclined upright surface 203, the swivel plate sleeve 104 will move. The first bump 300 will get stuck in the groove 109 on the swivel plate 107. The left end of the convex column 106 will contact the inclined upright surface 203.

With the aforementioned the Construction, the clamping mechanism of this invention is like this. Press on the handle 12 with one hand and push the push rod 4 in the direction of the left end of the shell 1, the push rod 4 will drive the top bar 9 and the joint lever 100 to move, the recoil spring 8 will be stretched, the clamping tube surface 401, the clamping helical surface 402 and the unclamping helical surface 400 will jack up the hinged plate 2 downwards. The right end of the first groove 5 pushes the slide claw sleeve 105 to move and the slide claw sleeve 105 will drive the swivel plate sleeve 104 to do the same. The compression spring 103 will be compressed. And when the front end of the clamping helical surface 402 gets stuck in the clamping groove 11, the first inclined plane 302 of the first bump 300 will be pushed against the tilted camber surface 201 and the second inclined plane 303 of the second convex block 301 will be pushed against the inclined upright plane 203 at the same time. At this very moment, the swivel plate sleeve 104 rotates; the first bump 300 gets stuck in the groove 109 on the swivel plate 107; the left end of the convex column 106 contacts the inclined upright plane 203. Once taking back the hand, the swivel plate sleeve 104 rotates. And now the left end of the convex column 106 will be pushed against the inclined upright plane 203 and the side face of the convex column 106 is pushed against the vertical surface hanger 202. In this way the locking action is completed. The round looped link 700 and the inclined looped link 701 are intermeshed which indicates that the clamping is done. The mechanism for unclamping is like this. Press on the handle 12 with one hand and push the push rod 4 in the direction of the left end of the shell 1, the first bump 300 and the second convex block 301 push against the swivel plate bump 200. The swivel plate sleeve 104 rotates. At this very moment, the convex column 106 gets stuck in the groove 109 on the swivel plate 107. The swivel plate sleeve 104 and the slide claw sleeve 105 moves to the right end of the shell 1 along the convex column 106. Then the unclamping action is performed. Reset the compression spring 103 which will drive the push rod 4 to move to the right end of the shell 1. The push rod 4 will drive the top bar 9 to move. Then the front end of the clamping helical surface 402 will be detached from the clamping groove 11. The unclamping helical surface helical surface 400, the clamping tube plane 401 will exit from the groove 10. The recoil spring 8 is reset. The hinged plate 2 moves upwards. The round looped link 700 and the inclined looped link 701 are detached separate. Then the unclamping is done. This invention is simple in the Construction. With one hand pushing the push rod 4 circularly, it can perform the unclamping and clamping functions. It satisfies the market needs with its easy operation, convenience and lower cost.

Above mentioned invention is only for the better example, since the specific example is not limiting to the invention. Within the technology categories of the invention, can appear all sorts of deformation and modification, where the embellish, modification, or equivalent replacement made by technology personnels in this field according to the above description, all belong to the range of the invention protection.

1. An automatic loop folder includes a shell in which there is a pair of pivotable hinged plates and clamped by the shell and several pairs of half-ring elements respectively fixed on the hinged plates, the said half-ring elements protrude out from the shell surface, it is characterized in: it also includes a push rod that is located inside the shell and can move along the axial direction of the shell, the said push rod is located below the said hinged plates, on the push rod from left to right are the 1^{st} continuous slot and the 2^{nd} continuous slot in sequence along the axial direction of the shell, the said 1^{st} slot is provided with a positioning sleeve of the automatic rotating push rod, upper end of the positioning sleeve of the said automatic rotating push rod is fixed on the inner surface of the shell, the said 2^{nd} slot is equipped with one recoil spring connecting with the hinged plates, upper end of the push rod is provided with several mandrils, there are continuous slots at the corresponding positions of the hinged plates, the said mandrils pass through the said continuous slots, and there is a neck on the inner surface of the shell, which matches with the front ends of the mandrils.

2. According to the description of the automatic loop folder given in claims 1, it is characterized in: the positioning sleeve of the said automatic rotating push rod comprises a connecting rod and a sleeve, cap bushed on the connecting rod, supporting drivepipe, compression spring in the supporting drivepipe, turnplate sleeve and slide pawl sleeve, the left end of the said connecting rod is connected to the left end of the 1^{st} continuous slot, the right end of the connecting rod is connected to the right end of the 1^{st} continuous slot, the upper end of the supporting drivepipe is fixed on the inner surface of the shell, left end of the supporting drivepipe is connected to the cap, there are three embossments on the inner surface of the right end of the supporting drivepipe, which are in parallel with the supporting drivepipe and uniformly distributed, right end of the turnplate sleeve protrudes into the slide pawl sleeve, right end of the slide pawl sleeve is close to the right end of the 1^{st} continuous slot, left end of the turnplate and left end of the slide pawl sleeve are respectively provided with turnplates and slide pawls, there are grooves corresponding to the said embossments on outer circumferential surfaces of the turnplate and pawl, turnplate sleeve and pawl sleeve can move inside the supporting drivepipe along the embossment via the groove, pawl sleeve can drive the turnplate sleeve to move and rotate, the said connecting rod is also provided with a connection block that is near the left end of the turnplate, one end of the said compression spring is connected with the cap while the other end is connected with the connection block.

3. Based on the automatic loop folder described in claims 2, its features are: the said grove divides the outer circumferential surface of the turnplate into the 3 embossments of the same size, right end of the said turnplate has an inclined curved surface, vertical plane and an inclined face in proper order, the said inclined arc and the said inclined face are the same in the inclined direction, the groove divides the slide pawl outer circumferential surface into 3 pairs of the pawl embossments of the same size, wherein each pair of the slide pawl embossments includes the first embossment and the second embossment separated from each other, the said first embossment and the second embossment are the same size and arranged side by side, left sides of the first embossment and the second embossment each have one first inclined surface and one second inclined surface, the said first inclined surface corresponds to the inclined arc, the second inclined surface corresponds to the inclined face, when the first inclined surface of the first embossment presses against the inclined arc and the second inclined surface of the inclined embossment presses against the inclined face, the turnplate sleeve rotates, the said first embossment enters the groove of the turntable, and the embossment left end contacts the inclined face.

4. Based on the automatic loop folder described in claims 1, it is characterized in: the said mandril is equipped in turn with integrally formed folder-open spiral surface, folder-close cylindrical surface and folder-close spiral surface, and front end of the folder-close spiral surface matches with the said neck.

5. Based on automatic loop folder described in claims 2, it is characterized in: both left and right sides of the upper end of the supporting sleeve are respectively equipped with the holder, middle of the upper end of the supporting sleeve is provided with the column, corresponding positions of the inner surface of the shell are provided with connection base and connection column that respectively connects with the buckles of the holder and the column.

6. Based on automatic loop folder described in claims 1, it is characterized in: the right end of the said push rod is provided with a handle located at the right end of the shell.

7. Based on automatic loop folder described in claims 6, it is characterized in: the right end surface of the shell extends upward by one baffle that is provided with a handle groove corresponding to the handle.

8. Based on automatic loop folder described in claims 2, it is characterized in: the right end of the cap stretches into the said support drivepipe, the right end surface of the cap is circumferentially and uniformly provided with three hooks, there are holes on the corresponding positions of the supporting drivepipe corresponding to the hooks, and the said hooks are buckled in the hook holes.

9. Based on automatic loop folder described in claim 1, it is characterized in: each pair of the said half-ring elements is composed of the round and oblique hook rings, and the said round hook ring and the said oblique hook ring can engage with each other.
